(19) United States
(12) Patent Application Publication
(10) Pub. No.: US 2003/0120777 A1
(43) Pub. Date: Jun. 26, 2003

(54) Forms auditing systems and methods

(75) Inventors: Mark Thompson, Denver, CO (US); Francis Aaron Henry, Denver, CO (US); David A. Owen, Castle Rock, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 10/032,796

(22) Filed: Dec. 26, 2001

(51) Int. Cl. G06F 15/16

(52) U.S. Cl. 709/225; 714/48

(57) ABSTRACT

A method of auditing forms comprises issuing a request to provide a form identifier from a form. The identifier is transmitted to a host computer that verifies whether the identifier is valid for the form being used. Further, an error is logged if the identifier is invalid.

### BACKGROUND OF THE INVENTION

This invention relates generally to the field of auditing, and in particular to the auditing of forms. More specifically, the invention relates to the auditing of forms that are used at multiple locations and that are periodically updated.

A variety of establishments use forms to conduct business transactions. Periodically, these forms are updated. However, if the forms find widespread use, it can be difficult to ensure that all old forms are discarded and replaced with the correct new forms. For example, a money transfer company may employ tens of thousands of agents throughout the world to assist in money transfer transactions, and each type of money transaction may involve a different form. As a result, hundreds of thousands of forms may be circulating at any time. Because such forms are periodically updated, the task of ensuring that all forms being used are the current forms can be difficult.

Hence, this invention is related to systems and methods to facilitate the auditing of forms. In this way, a system is in place to ensure proper forms are being used.

### BRIEF SUMMARY OF THE INVENTION

The invention provides systems and methods for auditing forms. Such forms may be for various business transactions or simply to gather information and may be used at a variety of locations. The systems and methods help to insure that updated forms are being used so that correct information may be gathered and/or disseminated.

In one embodiment, a method for auditing forms proceeds by issuing a request to provide a form identifier that is associated with a form. This request may be issued from a terminal with a display screen, such as when attempting to use the terminal to perform a business transaction. Alternatively, the request may be made by an auditor over a phone. The identifier for the form being used is sent to a host computer that verifies whether the identifier is a valid identifier for the form being used. The identifier may be sent to the host computer from the terminal, or entered by the auditor into another computer and then electrically sent to the host computer. If the identifier is not valid, the host computer logs an error.

In one aspect, the host computer may include an associated database so that the identifier may be verified by comparing the identifier with a list of valid identifiers in the database. This process may be repeated for each form being used. In this way, a wide variety of forms that are distributed over a large geographic region may efficiently be audited.

If an error is logged, the method also provides for determining whether an appropriate form has already been ordered. If not, an order for an appropriate form is placed so that an old form may be replaced with a current form. After a certain time, an evaluation is performed to determine whether the ordered form is received by the recipient. This may be confirmed, for example, by transmitting an identifier for the replacement form to the host computer to verify that the correct form has been received.

The invention also provides a forms auditing system that comprises a host computer and a database that is associated with the host computer. The database has a record of a set of forms and a valid identifier for each of the forms. Further, the host computer is configured to receive an identifier in response to a request to audit a form. The host computer is then configured to verify whether the identifier is a valid identifier for the audited form by comparing the identifier with the identifiers in the database, and to produce a record in the database of the comparison. If the identifier is not valid, the host computer may generate a report indicating that a new form needs to be sent to replace the old form.

The system may also include a terminal having a processor for at least some of the locations where the forms are used. Each terminal may be configured to receive the identifier of the form being audited and to electronically send the identifier to the host computer. Conveniently, the terminal may be configured to produce an audit screen having a region for inputting the identifier. This screen may be produced each time the system is logged on to, or a selective times. Further prompts may be provided to enter identifiers for random forms. This audit screen may be stored locally at the terminal or may be electronically sent from the host computer.

### BRIEF DESCRIPTION OF THE DRAWINGS

FIG. 1 is a schematic diagram of a forms auditing system according to the invention.

FIG. 2 is a flow chart illustrating one method for auditing forms using a computer terminal according to the invention.

FIG. 3 is a flow chart illustrating another method for auditing forms based on input from an auditor according to the invention.

FIG. 4 is a flow chart illustrating an alternative method for auditing forms based on input from an auditor.

### DETAILED DESCRIPTION OF THE INVENTION

The invention provides various systems and method for auditing forms, and in particular to determine if an appropriate version of a form is being used. The invention may be used with essentially any type of form that is periodically updated or revised. Such forms may be forms printed on some type of media, such as paper, that have regions or fields for entering various types of information. For example the fields may relate to various business information such as customer name and address, goods being purchased or shipped, a monetary value, a payee or vendor, and the like. Non-limiting examples of forms that may be used include, for example, money transfer forms, bill payment forms, purchase order forms, order fulfillment forms, tax forms, and the like. Such forms may be used in a variety of businesses or organizations, such as money transfer businesses, bill payment businesses, retailers, wholesales, and the like.

The invention is especially useful when a business or organization uses multiple forms at a variety of locations, and provides ways to efficiently and comprehensively determine whether current forms are being used. Further, if incorrect forms are detected, the invention provides various ways to replace the incorrect forms and to ensure these forms are being used.

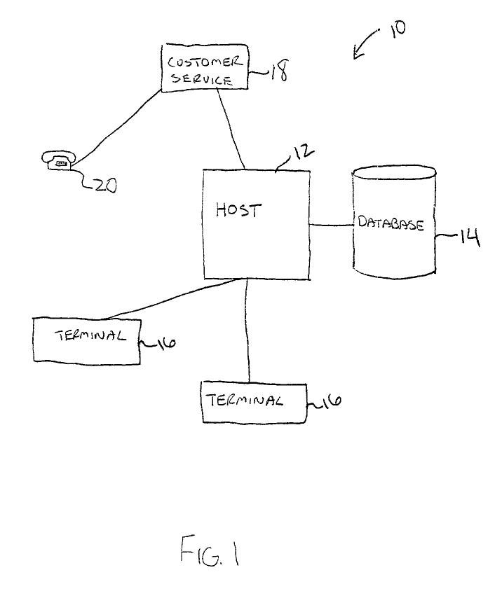

Referring now to FIG. 1, one system 10 that may be used to audit such forms will be described. System 10 utilizes a host computer 12 that communicates with a database 14. Host computer 12 may comprise essentially any type of computer that may be remotely accessed, such as for example, a mainframe computer (such as a Tandem computer system), a web server computer and the like.

System 10 further comprises a plurality of remote computers or terminals 16. Terminals 16 may be essentially any type of device having a processor, memory, input device and display screen. Examples of terminals that may be used include conventional desk top personal computers, laptop computers, point of sale devices, such as those described in copending U.S. application Ser. No. 09/634,901, entitled “POINT OF SALE PAYMENT SYSTEM,” filed Aug. 9, 2000 by Randy J. Templeton et al., which is a nonprovisional of U.S. Prov. Appl. No. 60/147,899, entitled “INTEGRATED POINT OF SALE DEVICE,” filed Aug. 9, 1999 by Randy Templeton et al, the complete disclosures of which are herein incorporated by reference, and the like. Terminals 16 are also able to communicate with host 12 over a dedicated line, via the Internet, wirelessly, or the like as is known in the art. Terminals 16 may be located at or near establishments where the forms are used. For example, a money transfer or bill payment business may have a variety of locations where a customer may visit to perform a transaction. Terminals 16 may be positioned at these locations.

Conveniently, host 12 and terminals 16 may also be configured to perform various money transfer transactions, bill payment transactions, service payment transactions, and similar transactions. These transactions may involve the use of the same forms that need to be audited. For example, to transfer money a customer may receive a money transfer form and fill in fields such as the recipient's name, the amount to transfer, the recipient's location, and the like. This information is entered into terminal 16 and transmitted to host 12. When the recipient is ready to receive the money, the recipient goes to a location having another terminal that communicates with host 12 to confirm the transfer to the recipient. Although described in the context of a money transfer system, it will be appreciated that the invention is not intended to be limited to such scenarios, but may be used with any system using a variety of forms as previously described.

To audit the various forms, database 14 ma include a record of current forms. This record may include identifiers that are also displayed on the forms. Such identifiers may be a string of alphanumeric characters, other symbols, bar codes, and the like. Periodically, a user of the forms may be requested to provide this identifier so an audit may be performed on the form being used. The identifier is transmitted to host computer 12 by terminals 16, by a customer service computer 18, or the like. Host computer 12 compares the identifier with the record in database 14 to determine if the correct form is being used. To initiate the audit, a user may be prompted to enter identifiers of one or more forms when logging into terminals 16. This prompting may be driven locally by each terminal or by host 12. Another way is for a customer service representative to periodically call users using a telephone 20 and ask them for identifiers on their forms. This information may then be entered into computer 18 and transmitted to host 12. The frequency and extent of the audit may be varied based on need.

The identifiers may be entered into terminals 16 in a variety of ways. For example, terminals 16 may display an audit screen having a field to type in the identifier. Other ways include using a scanner or OCR reader, using voice recognition, using a touch screen, and the like.

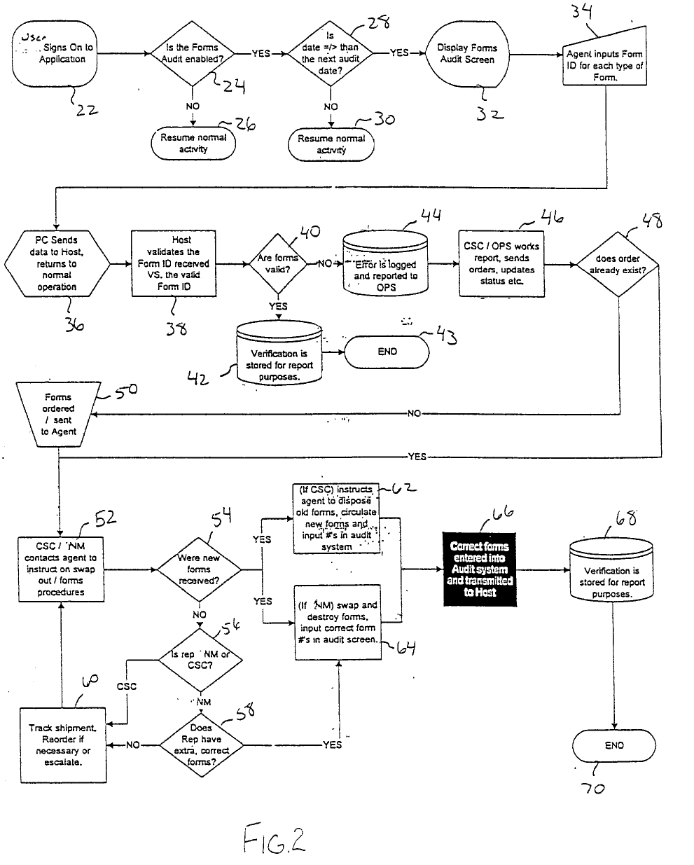

Referring now to FIG. 2, one method for auditing forms will be described. Conveniently, the method of FIG. 2 may be carried out using system 10 of FIG. 1. The auditing process begins at step 22 where the user signs on to a certain application. This application may be accessed from one of terminals 16. At step 24, a determination is made as to whether the forms audit feature is enabled. This may be based on the configuration of terminal 16 or come from host 12. If no audit is to be performed, the normal activity using the form is continued as shown in step 26. If enabled, the process proceeds to step 28 where a check is performed to determine whether this date is one where an audit should be performed. The frequency of the audits may be set at terminal 16 or host 12. If no audit is scheduled, normal activity resumes at step 30.

If an audit is scheduled, a forms audit screen is displayed at the terminal as shown in step 32. The forms audit screen may ask for identifiers for one or more different types of forms, and these identifiers are entered at step 34. This information is sent from terminal 16 to host 12 as shown in step 36, and normal operation of terminal 16 resumes so that a transaction or other business activity may occur. At step 38, host 12 compares the entered identifiers with those stored in database 14 to determine if valid. If so, the verification is stored in database 14 for report purposes at step 42 and the process ends at step 43.

If one or more of the forms is not valid, an error is logged and transmitted to an operations system (OPS) as shown in step 44. In step 46, the report is evaluated to determine what forms are being used and how to ensure that the user has a correct set of forms. Before sending out new forms, a check is done at step 48 to see if an order for these forms has already been placed. If not, the new forms are ordered at step 50 and sent to the user at step 52, and a customer service center (CSC) or a user network management system (NM) contacts the user to make sure the old forms are replaced with the new forms. The NM may comprise individuals and/or equipment that oversees and manages a network of users.

As one example, the user may be asked whether the new forms were received at step 54. If not, a follow up may be performed based on whether the representative is from the NM or the CSC as shown in step 56. If from the NM, it is determined whether the NM representative has the correct forms. If not, the shipment is tracked at step 60 and new forms may be ordered. If a CSC representative, the process may proceed directly to step 60.

If new forms were received, the CSC may instruct the user to dispose the old form and to se the new forms. The identifiers from the new forms may be entered into terminal 16 as shown in step 62. If a NM representative, the forms are swapped and destroyed as shown in step 64. Information on the new form is transmitted to host 12 as shown in step 66, and the verification is stored at step 68. The process then ends at step 70.

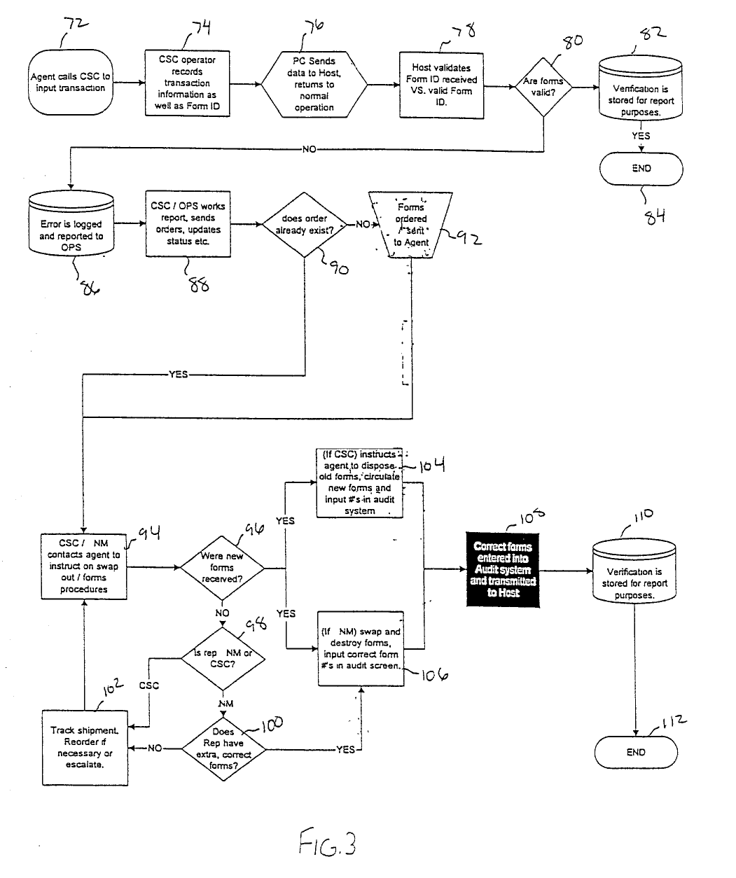

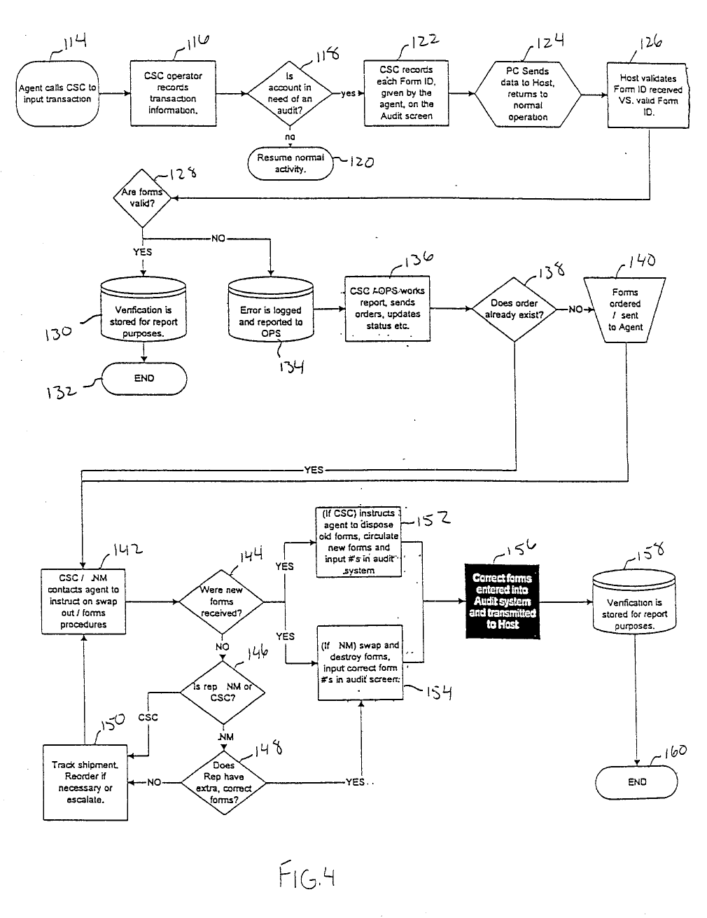

The methods set forth in FIGS. 3 and 4 may be used when a user does not have a terminal to enter the identifiers on the forms. Initially, a user calls a CSC to have the CSC enter a transaction into terminal 18 as shown in step 72. At step 74, the CSC operator enters the transaction information into the terminal along with the form identifier. Computer 18 sends this data to host 12 and then returns to normal operation as shown in step 76. Host 12 receives the form identifiers and validates the identifier using records in database 14 as shown in step 78. If the forms are valid (step 80), a verification is stored in database 14 at step 82 and the process ends at step 84.

If the forms are not valid, an error is logged and reported to OPS as shown in step 86. The process then proceeds to steps 88 through 112 which are essentially identical to steps 46 through 70 of FIG. 2 and will not be described further.

The process if FIG. 4 is similar to that of FIG. 3 except that an audit is not automatically performed each time a transaction is processed. At step 114 a user calls a CSC to input a transaction at computer 18. The transaction information is entered into computer 18 at step 116. Before this information is sent to host 12, a determination is made as to whether the account is in need of an audit as shown in step 118. This determination may be made by computer 18 or supplied by host 12 and may be based on various factors, such as the length of time since the last audit, whether new forms have recently been issued, and the like. If no audit is needed, normal operation is resumed as shown in step 120. If an audit is needed, an audit screen is produced on computer 18 to permit the form identifiers given by the user to be input as shown in step 122. The form identifiers are transmitted to host 12 as shown in step 124 where they may be validated in step 126. The process then proceeds to steps 128 through 160 which may be the same as steps 80 thorough 112 of FIG. 3 and will note be described further.

The invention has now been described in detail for purposes of clarity and understanding. However, it will be appreciated that certain changes and modifications may be practiced within the scope of the appended claims.

What is claimed is:

1. A method for auditing forms, the method comprising:
issuing a request to provide a form identifier that is associated with a form;
receiving the identifier at a host computer;
verifying with the host computer whether the identifier is a valid identifier for the form being used;
logging an error if the identifier is not valid.

2. A method as in claim 1, wherein the request is issued from a terminal having a processor that is in communication with the host computer.

3. A method as in claim 2, wherein the request is sent from the host computer to the terminal.

4. A method as in claim 1, where the request is issued from a customer service operator over a phone.

5. A method as in claim 2, wherein the identifier is received at the host computer from the terminal.

6. A method as in claim 1, wherein the host computer includes an associated database, and wherein the identifier is verified by comparing the identifier with a list of valid identifiers in the database.

7. A method as in claim 1, further comprising determining whether an appropriate form has already been ordered.

8. A method as in claim 7, wherein if an appropriate form has not been ordered, placing an order for an appropriate form.

9. A method as in claim 8, further comprising evaluating whether the ordered form is received by a user.

10. A method as in claim 9, further comprising transmitting an identifier for a replacement form to the host computer.

11. A forms auditing system, comprising:
a host computer; and
a database associated with the host computer, the database having a record of a set of forms and a valid identifier for each of the forms;
wherein the host computer is configured to receive an identifier in response to a request to audit a form, and to verify whether the identifier is a valid identifier for the audited form by comparing the identifier with the identifiers in the database, and to produce a record in the database of the comparison.

12. A system as in claim 11, further comprising a terminal having a processor, wherein the terminal is configured to receive the identifier of the form being audited and to electronically send the identifier to the host computer.

13. A system as in claim 12, wherein the terminal is configured to produce an audit screen having a region for inputting the identifier.

14. A system as in claim 13, wherein the terminal is configured to produce the audit screen based on information sent to the terminal from the host computer.

15. A system as in claim 11, wherein the host computer is configured to generate in error report if the identifier of the form being audited is not valid.
